(19) United States
(12) Patent Application Publication
(10) Pub. No.: US 2015/0339248 A1
(43) Pub. Date: Nov. 26, 2015

(54) METHOD AND APPARATUS FOR PROCESSING DATA

(71) Applicant: ELECTRONICS AND TELECOMMUNICATIONS RESEARCH INSTITUTE, Daejeon (KR)

(72) Inventor: Woo Young CHOI, Daejeon (KR)

(21) Appl. No.: 14/697,999

(22) Filed: Apr. 28, 2015

(30) Foreign Application Priority Data
May 26, 2014 (KR) 10-2014-0062854

(51) Int. Cl. G06F 13/364; G06F 13/40; G06F 13/42

(52) U.S. Cl. CPC G06F 13/364; G06F 13/4282; G06F 13/404

(57) ABSTRACT

A data processing method and a data processing apparatus are disclosed. The data processing method may include determining whether a device address included in a signal received from a master device is a registered group device address, and processing data by accessing one or more slave devices mapped to the registered group device address when the device address is the registered group device address.

### CROSS-REFERENCE TO RELATED APPLICATION

This application claims the priority benefit of Korean Patent Application No. 10-2014-0062854, filed on May 26, 2014, in the Korean Intellectual Property Office, the disclosure of which is incorporated herein by reference.

### BACKGROUND

1. Field of the Invention

Embodiments of the present invention relate to a method of processing data by accessing a device through an Inter-Integrated Circuit (I2C) interface and a data processing apparatus.

2. Description of the Related Art

Generally, a microprocessor for high-performance processing uses a low-speed serial bus interface in accordance with the Inter-Integrated Circuit (I2C) protocol, for communications with low-speed peripheral devices. In detail, an I2C interface is a serial bus standard using one unidirectional clock line and one bidirectional data line. Here, the I2C interface may include a single I2C master device and I2C slave devices allocated individual device addresses. The I2C master device and the slave devices are connected in a bus form using a serial clock (SCL) line and a serial data (SDA) line to conduct communications based on the I2C protocol.

A Media Independent Interface (MII) provides a management interface between PHY layers and MAC(media access control) using a Management Data Input/Output (MDIO) line and a Media Data Clock (MDC) line.

### SUMMARY

According to an aspect of the present invention, there is provided a method of processing data including determining whether a device address included in a signal received from a master device is a registered group device address; and processing data by accessing one or more slave devices mapped to the registered group device address when the device address is the registered group device address.

The method may further include grouping one or more slave devices according to a preset criterion to map the slave devices to a group device address; and registering the mapped group device address.

The registering may register the mapped group device address when a data processing apparatus is initialized or while the data processing apparatus is operating.

According to another aspect of the present invention, there is provided a method of processing data including determining whether a device address included in a signal received from a master device is a registered group device address; and transmitting a data processing instruction to a slave device allocated a device address when the device address is the device address allocated to the slave device.

The method may further include grouping one or more slave devices according to a preset criterion to map the slave devices to a group device address; and registering the mapped group device address.

The transmitting may transmit the data processing instruction to the slave device via a bypass.

According to still another aspect of the present invention, there is provided a method of processing data including grouping one or more slave devices according to a preset criterion to map the slave devices to a group device address; registering the mapped group device address; and processing data by accessing one or more slave devices corresponding to the registered group device address.

The mapping may group one or more slave devices having the same device address or one or more slave devices having the same register and map the slave devices to a group device address.

According to yet another aspect of the present invention, there is provided a method of processing data including determining whether to access an Media Independent Interface (MII)-based slave device using identification information included in a signal received from an integrated circuit serial interface-based master device; and processing data by accessing the MII-based slave device or an MII-based slave device group when it is determined to access the MII-based slave device.

The determining may convert the received signal into an MII format when the identification information included in the received signal corresponds to identification information in accordance with a preset criterion.

The received signal may be mapped to a device address and a register address of the MII-based slave device.

The determining may include determining whether a device address of the MII-based slave device mapped to the received signal is registered; and accessing the MII-based slave device corresponding to the device address or the MII-based slave device group when the device address is determined to be registered.

According to still another aspect of the present invention, there is provided an apparatus for processing data including a determination unit to determine whether a device address included in a signal received from a master device is a registered group device address; and a processing unit to process data by accessing one or more slave devices mapped to the registered group device address when the device address is the registered group device address

The data processing apparatus may group one or more slave devices according to a preset criterion to map the slave devices to a group device address and registers the mapped group device address.

According to yet another aspect of the present invention, there is provided an apparatus for processing data including a determination unit to determine a device address included in a signal received from a master device is a registered group device address; and a transmission unit to transmit a data processing instruction to a slave device allocated a device address when the device address is the device address allocated to the slave device.

The transmission unit may transmit the data processing instruction to the slave device allocated the device address via a bypass.

According to an aspect of the present invention, there is provided an apparatus for processing data including a mapping unit to group one or more slave devices according to a preset criterion to map the slave devices to a group device address; a registration unit to register the mapped group device address; and a processing unit to process data by accessing one or more slave devices corresponding to the registered group device address.

The mapping unit may group one or more slave devices having the same device address or one or more slave devices having the same register.

According to an aspect of the present invention, there is provided an apparatus for processing data including a determination unit to determine whether to access an Media Independent Interface (MII)-based slave device using identification information included in a signal received from an integrated circuit serial interface-based master device; and a processing unit to process data by accessing the MII-based slave device when it is determined to access the MII-based slave device.

The determination unit may determine whether a device address of the MII-based slave device mapped to the received signal is registered and access the MII-based slave device corresponding to the device address or an Mil-based slave device group when the device address is determined to be registered.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a relationship between a data processing apparatus and a device according to an embodiment;

FIG. 2 illustrates a method of processing data by accessing a slave device group through a group device address according to an embodiment;

FIG. 3 illustrates a method of processing data by accessing a slave device through a device address according to an embodiment;

FIG. 4 illustrates a method of processing data by accessing a slave device group through registration of a group device address according to an embodiment;

FIG. 5 illustrates a method of processing data by an integrated circuit serial interface-based device accessing a Media Independent Interface (MII)-based device according to an embodiment;

FIG. 6 illustrates a relationship between a data processing apparatus and a slave device according to an embodiment;

FIG. 7 illustrates a write instruction processing method of the data processing apparatus through an I2C protocol according to an embodiment;

FIG. 8 illustrates a read instruction processing method of the data processing apparatus through the I2C protocol according to an embodiment;

FIGS. 9A and 9B illustrate a format of a 10-bit address based on the I2C interface according to an embodiment;

FIGS. 10A and 10B illustrate a format of an MII signal according to an embodiment;

FIG. 11 illustrates a method of converting an I2C interface signal to an MII signal according to an embodiment;

FIG. 12 illustrates a data processing apparatus which processes data by accessing a slave device group through a group device address according to an embodiment;

FIG. 13 illustrates a data processing apparatus which processes data by accessing a slave device through a device address according to an embodiment;

FIG. 14 illustrates a data processing apparatus which processes data by accessing a slave device group through registration of a group device address according to an embodiment; and

FIG. 15 illustrates a data processing apparatus which processes data by an integrated circuit serial interface-based device accessing a Media Independent Interface-based device according to an embodiment.

### DETAILED DESCRIPTION

Hereinafter, exemplary embodiments of the present invention will be described in detail with reference to the accompanying drawings.

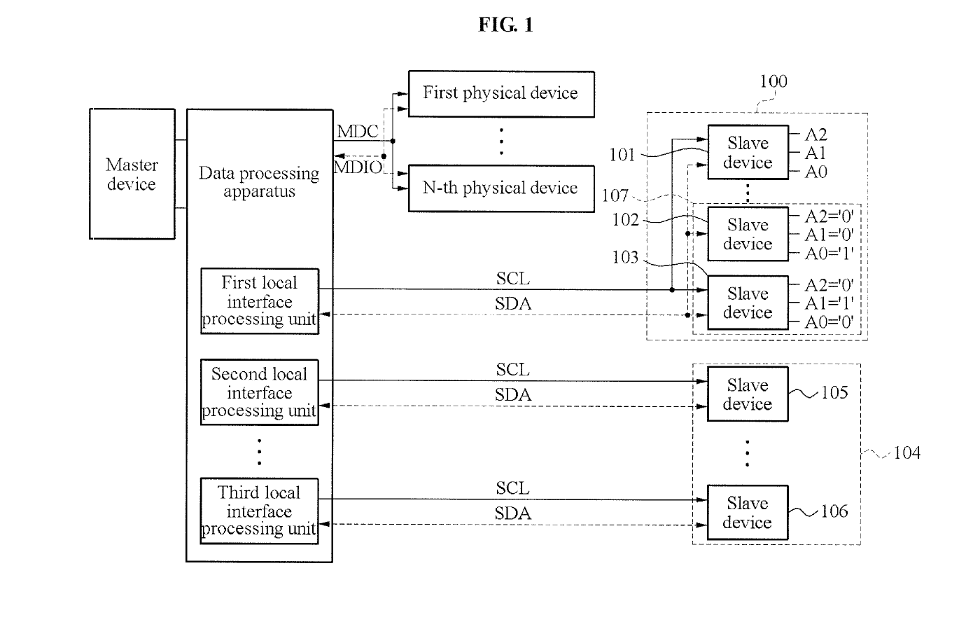

FIG. 1 illustrates a relationship between a data processing apparatus and a device according to an embodiment.

The data processing apparatus may access a slave device using a serial clock (SCL) line and a serial data (SDA) line in accordance with an Inter-Integrated Circuit (I2C) protocol. On the basis of the I2C protocol, the data processing apparatus may identify a slave device including data to be processed through an individual device address set to seven bits or ten bits. Here, the data processing apparatus may group slave devices into a group according to a preset criterion. The data processing apparatus may map the grouped slave devices to a group device address.

For instance, a plurality of slave devices 100, 102, 103, 105 and 106 may have individual device address. Here, the data processing apparatus may group one or more slave devices having the same device address or one or more slave devices having the same register among the plurality of slave devices 100, 102, 103, 105 and 106 into a group. That is, the data processing apparatus may generate one or more slave device groups.

The data processing apparatus may map the generated slave device groups 100 and 104 to separate group device addresses. Here, the group device addresses of the slave device groups may be allocated, separate from the device addresses of the slave devices 100, 102, 103, 105 and 106.

For example, referring to FIG. 1, the slave device group 100 may include slave devices 101, 102 and 103 allocated individual device addresses. For instance, the device addresses of the slave devices 101, 102 and 103 in the slave device group 100 may include higher bit fields and lower bit fields. Here, the higher bit fields may have the same value. Including the same higher bit field may mean having the same internal register map. For example, the lower bits may be set through an external pin. Thus, the slave devices 101, 102 and 103 included in the slave device group 100 may be identified by the lower bit fields of the device addresses.

The slave device group 104 may include slave devices 105 and 106 allocated individual device addresses. Here, the slave devices 105 and 106 may be allocated the same device address. Thus, the data processing apparatus may be connected to the slave devices 105 and 106 through separate SCL lines and SDA lines.

Accordingly, the data processing apparatus may transmit/receive data to/from the slave devices through the device addresses. Further, the data processing apparatus may transmit/receive data to/from the grouped slave devices through a group device. That is, the data processing apparatus may simultaneously access one more slave devices mapped to the same group device address to process data.

For instance, the data processing apparatus may access a slave device allocated a device address to process data. Specifically, a device address of a slave device may be set to “1001001.” Alternatively, a group device address of a group slave device may be set to “1001000.”

Here, a master device may transmit “1001001” as a device address to the data processing apparatus. In addition, the master device may transmit a read/write (R/W) instruction bit. Since the received device address is the device address, the data processing apparatus may bypass the SCL line and the SDA line. The data processing apparatus may access the slave device through an I2C bus. The slave device may receive and identify the device address from the data processing apparatus.

When the device address is identified, the slave device may connect to the data processing apparatus based on an I2C interface. Accordingly, the data processing apparatus and the slave device may communicate directly with each other, and transmit and receive data.

For instance, the data processing apparatus may access a slave device included in a group slave device to process data. For example, it may be assumed that a device address of a first slave device is “1001001.” It may be assumed that a device address of a second slave device is “1001010.” It may be assumed that a group device address of the group slave device is “1001000.” Here, the group slave device may include the first slave device and the second slave device.

Here, the data processing apparatus may simultaneously access the first slave device and the second slave device included in the group slave device using the group device address “1001000.” Accordingly, the data processing apparatus may process data simultaneously with respect to the first slave device and the second slave device.

The data processing apparatus may access a Media Independent Interface (MII)-based slave device using the I2C interface. Accordingly, even when not supporting the MII, the data processing apparatus may transmit/receive data to/from the MII-based slave device.

In detail, the data processing apparatus may receive a signal including identification information from a master device based on the I2C interface (“I2C interface-based master device”). Here, the signal may be generated on the basis of an I2C interface format. The data processing apparatus may determine whether to access the MII-based slave device using the identification information. When the data processing apparatus determines to access the MII-based slave device, the data processing apparatus may access a register of the MII-based slave device to process data using a device address and a register address of the MII-based slave device included in the signal received from the I2C interface-based master device. Here, the data processing apparatus may separately access the MII-based slave device to process data. Alternatively, the data processing apparatus may simultaneously access a group slave device of MII-based slaved devices to process data.

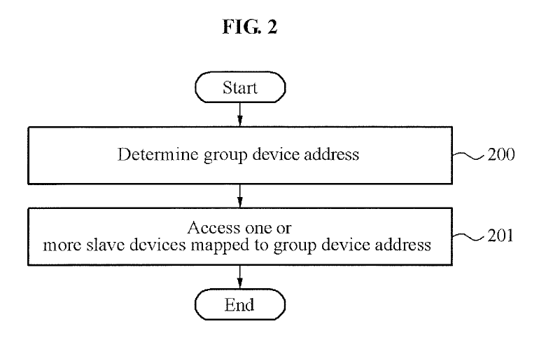

FIG. 2 illustrates a method of processing data by accessing a slave device group through a group device address according to an embodiment.

Referring to FIG. 2, in operation 200, the data processing apparatus may determine a device address included in a data processing request signal received from the master device is a registered group device address.

In operation 201, when the device address is a registered group device address, the data processing apparatus may access one or more slave devices mapped to the registered group device address to process data.

Here, the data processing apparatus may group one or more slave devices according to a preset criterion to map the slave devices to a group device address. Here, the preset criterion may mean that slave devices have the same device address or have the same register. In detail, slave devices having the same register may mean that the slave devices have the same higher bits to have the same internal register maps.

The data processing apparatus may register the mapped group device address so that the master device may access the slave devices using the group device address, separately from accessing the slave devices through a device address. Here, the data processing apparatus may register the mapped group device address when the data processing apparatus is initialized or while the data processing apparatus is operating.

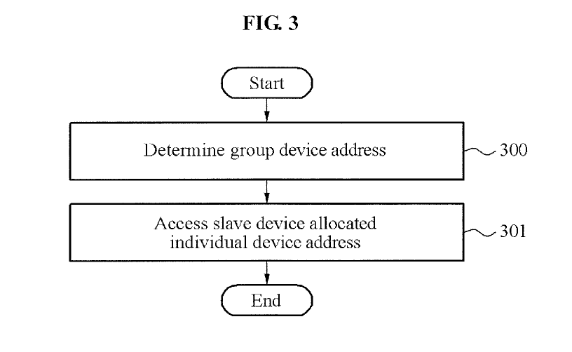

FIG. 3 illustrates a method of processing data by accessing a slave device through a device address according to an embodiment.

Referring to FIG. 3, in operation 300, the data processing apparatus may determine whether a device address included in a signal received from the master device is a registered group device address.

In operation 301, when the device address included in the received signal is a device address allocated to a slave device, the data processing apparatus may transmit a data processing instruction to the slave device allocated the device address. That is, when the device address included in the signal received from the master device is not a group device address but a device address allocated to an individual slave device, the data processing apparatus may transmit the data processing instruction to the slave device corresponding to the device address included in the received signal.

Here, the data processing apparatus may transmit the data processing instruction via a bypass to the slave device corresponding to the device address included in the received signal. Accordingly, the slave device may determine whether to process data on the basis of device address information included in the data processing instruction. When the device address included in the data processing instruction corresponds with the device address of the slave device receiving the data processing instruction, the data processing apparatus may access the slave device to process data.

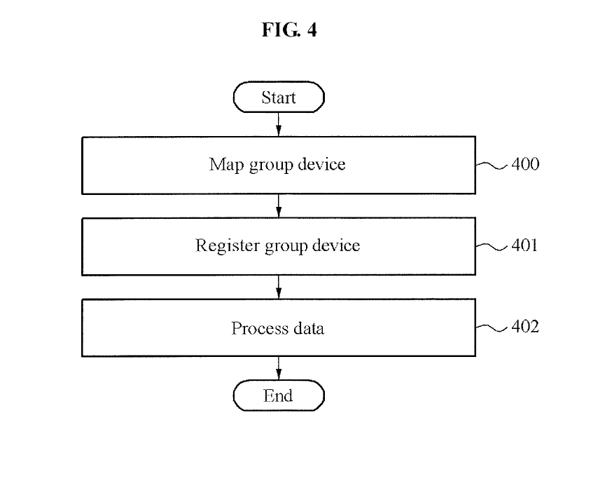

FIG. 4 illustrates a method of processing data by accessing a slave device group through registration of a group device address according to an embodiment.

Referring to FIG. 4, in operation 400, the data processing apparatus may group one or more slave devices according to a preset criterion and map the slave devices to a group device address. For example, the preset criterion may specify that one or more slave devices having the same device address or one or more slave devices having the same register are grouped and mapped to a group device address. In detail, slave devices having the same register may mean that the slave devices have the same higher bits to have the same internal register maps.

In operation 401, the data processing apparatus may register the mapped group device address. In operation 402, the data processing apparatus may access one or more slave devices corresponding to the registered group device address to process data. Accordingly, the data processing apparatus may simultaneously access registers of the one or more slave devices to process data.

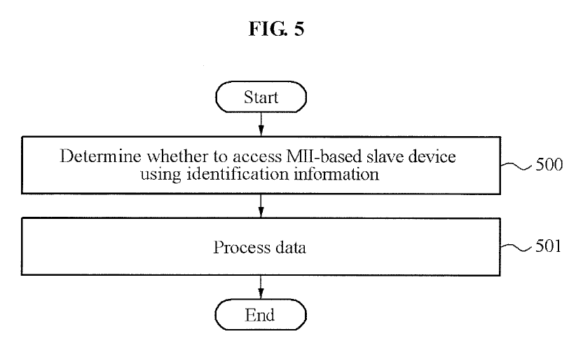

FIG. 5 illustrates a method of processing data by an integrated circuit serial interface-based device accessing a Media Independent Interface-based device according to an embodiment.

The data processing apparatus may receive a signal from a master device based on an integrated circuit serial interface (“integrated circuit serial interface-based master device”). Here, the integrated circuit serial interface may refer to an I2C. The Media Independent Interface may be represented by MII. Here, the data processing apparatus may determine whether to access the MII-based slave device using identification information included in the signal received from the integrated circuit serial interface-based master device. Here, the Media Independent Interface may be referred to as MII.

In operation 500, the data processing apparatus may determine whether to access the MII-based slave device using the identification information included in the signal received from the integrated circuit serial interface-based master device. In detail, when the identification information corresponds with a preset criterion, the data processing apparatus may access the MII-based slave device. Here, the preset criterion may be set at discretion by an administrator or by the data processing apparatus.

For example, the data processing apparatus may receive a signal including an address bit of a first slave device with “1111_{—}0xxx” input through an SCL line and an SDA line. Here, “1111_{—}0xxx” may represent identification information. When identification information preset by the data processing apparatus includes “1111_{—}0xxx,” the data processing apparatus may access the MII-based slave device.

When the data processing apparatus accesses the MII-based slave device, the data processing apparatus may determine whether the device address included in the signal received from the master device is a device address of the MII-based slave device or a group device address of one or more MII-based slave device groups. Accordingly, the data processing apparatus may convert the received signal into an MII format to access the MII-based slave device.

For example, the data processing apparatus may register the device address of the MII-based slave device. Also, the data processing apparatus may store a device address of an MII-based slave device group. Here, the data processing apparatus may adjust the device address of the MII-based slave device through an external pin to identify a slave device included in the slave device group.

For instance, the signal received by the data processing apparatus from the integrated circuit serial interface-based master device may be mapped to the device address of the MII-based slave device and a register address thereof. Accordingly, the data processing apparatus may determine whether the device address of the MII-based slave device mapped to the received signal is registered.

When the device address of the MII-based slave device mapped to the received signal is determined to be registered in the data processing apparatus, the data processing apparatus may access the MII-based slave device corresponding to the device address.

In operation 501, the data processing apparatus may access the MII-based slave device to process data. In detail, the data processing apparatus may convert the signal received from the integrated circuit serial interface-based master device into an MII format. Accordingly, the data processing apparatus may access the MII-based slave device using the converted signal, thereby processing data.

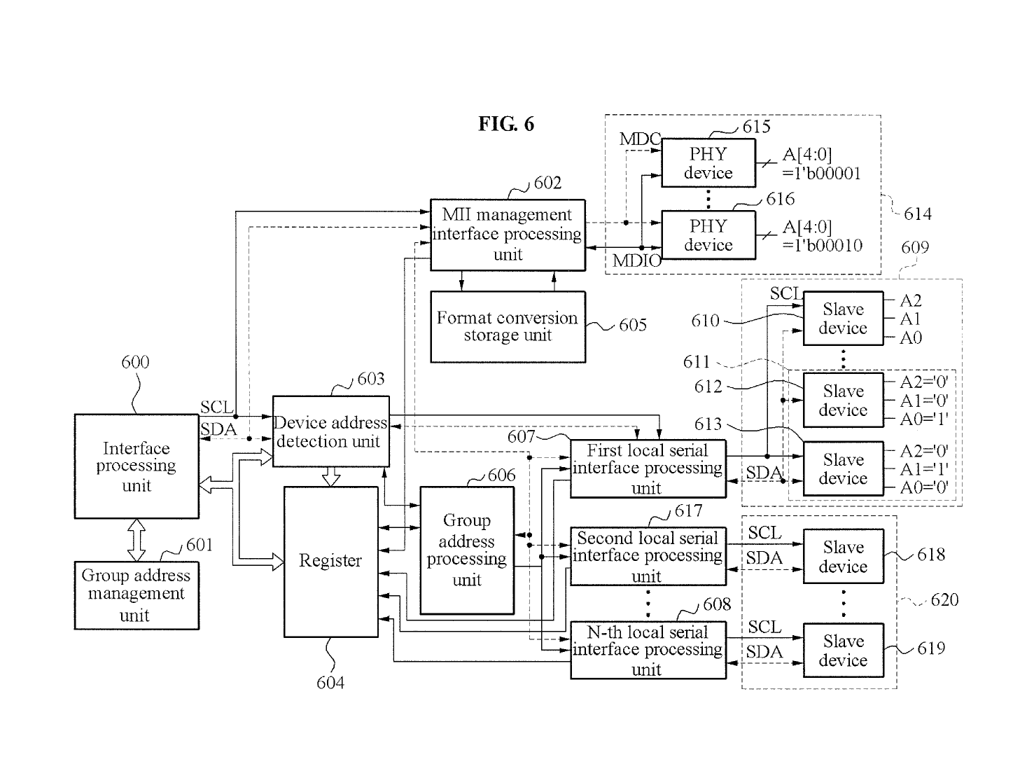

FIG. 6 illustrates a relationship between a data processing apparatus and a slave device according to an embodiment.

Referring to FIG. 6, the data processing apparatus may be connected to a plurality of slave devices 610, 612 and 613 or physical (PHY) devices 615 and 616. Here, the plurality of slave devices 610, 612 and 613 may refer to integrated circuit serial interface-based slave devices. Further, the PHY devices 615 and 616 may refer to MII-based slave devices.

The data processing apparatus may include an interface processing unit 600, a device address detection unit 603, a group address processing unit 606, a register 604, a plurality of local serial interface processing units 607, 608 and 617, an MII management interface processing unit 602, and a group address management unit 601. Here, the register 604 may include a write information register, a device allocation register, and a read information register.

The plurality of slave devices 610, 612 and 613 may have individual device addresses. Here, the group address management unit 601 may group one or more slave devices having the same device address or one or more slave devices having the same register among the plurality of slave devices into a group. That is, the group address management unit 601 may generate one or more slave device groups.

An I2C interface signal may include an N-bit device address format. For instance, the I2C interface signal may include a 7-bit or 10-bit device address format. Here, when the 7-bit device address format is used, a slave device group 611 and the slave devices 610, 612 and 613 may have a 7-bit device address.

For example, device addresses of the slave devices 612 and 613 included in a slave device group 611 may include higher bit fields and lower bit fields. The higher bit fields may have the same value. Here, having the same higher bit field means having the same internal register map.

For instance, a lower bit may be set through an external pin. Thus, the slave devices 612 and 613 in the slave device group 611 may be identified by the lower bit fields of the device addresses.

Referring to FIG. 6, lower bits included in the device addresses of the slave devices 612 and 613 may be changed using three external pins A0, A1 and A2. The device addresses of the slave devices 612 and 613 may have the same addresses in higher four bits. Here, the device addresses of the slave devices 612 and 613 may be identified by lower three bits input through the external pins A2, A1 and A0.

For example, a slave device may be allocated a device address of “1001A2A1A0.” Specifically, the slave device 612 may be allocated a device address of “1001001.” The slave device 613 may be allocated a device address of “1001010.” The slave device group 611 may be allocated a group device address of “1001000.”

The group address management unit 601 may map a slave device group to a separate group device address. Here, the group device address of the slave device group may be allocated separately from the device addresses of the slave devices 610, 612 and 613.

The group address management unit 601 may transmit slave device group information and group device address information to the device address detection unit 603 through the interface processing unit 600. The device address detection unit 603 may register the slave device group information and the group device address information mapped with the slave device group. Further, the device address detection unit 603 may receive mapping cancelation request information transmitted by the group address management unit 601 through the interface processing unit 600. That is, the device address detection unit 603 may manage the group device address information.

The interface processing unit 600 may receive an input from a higher processor. The data processing apparatus may receive a data processing instruction from the interface processing unit 600 to access registers of the slave devices 610, 612 and 613 based on the I2C interface. Accordingly, the data processing apparatus may conduct a read or write in an internal register of the slave devices based on the I2C interface.

The interface processing unit 600 may include a serial interface processing unit and a parallel interface processing unit. The serial interface processing unit may refer to an I2C interface-based master device. That is, the serial interface processing unit may transmit and receive data using an SCL line and an SDA line based on the I2C interface.

The parallel interface processing unit may access the register 604. In detail, the parallel interface processing unit may be connected to the register 604 and the device address detection unit 603 through a local bus including a plurality of address lines, a plurality of data lines and control signals.

Further, the interface processing unit 600 may serve as an interface between the group address management unit 601 and the device address detection unit 603. In detail, the interface processing unit 600 may receive a registration request or cancelation request for a group device address from the group address management unit 601. Then, the interface processing unit 600 may transmit the registration request or cancelation request for the group device address to the address detection unit 603. When the registration request or cancelation request for the group device address is received, the device address detection unit 603 may register or cancel the group device address.

Here, the group address management unit 601 may transmit the registration request or cancelation request for the group device address to the device address detection unit 603 through the serial interface processing unit or the parallel interface processing unit. When the registration request or cancelation request for the group device address is transmitted through the serial interface processing unit, the group address management unit 601 may transmit the registration request or cancelation request for the group device address using a device address allocated to the device address detection unit 603. That is, the group address management unit 601 may transmit the registration request or cancelation request for the group device address to the device address detection unit 603 through the I2C bus. Further, when the registration request or cancelation request for the group device address is transmitted through the parallel interface processing unit, the group address management 601 may transmit the registration request or cancelation request for the group device address using a local bus address allocated to the device address detection unit 603. That is, the group address management unit 601 may transmit the registration request or cancelation request for the group device address to the device address detection unit 603 through the local bus.

The device address detection unit 603 may register the group device address through the interface processing unit 600 when the data processing apparatus is initialized or while the data processing apparatus is operating. Also, the device address detection unit 603 may determine whether a device address received from the serial interface processing unit is a registered group device address. When the received device address is a registered group device address, the device address detection unit 603 may access one or more slave device corresponding to the group device address.

For example, the write information register may receive an R/W bit followed a group device address bit over an I2C interface signal. Here, the group device address bit may include a group device address. The R/W bit may include a read instruction or a write instruction. Here, when the write instruction is input in the R/W bit, the write information register may identify an internal register address of a slave device and write data from the serial interface processing unit. For instance, the write information register may receive and store the register address of the slave device and the write data through a signal in an I2C interface format.

For example, the read information register may receive a group device address bit and an R/W bit. Here, when a read instruction is included in the R/W bit, the read information register may collect and store a register address of a slave device in an I2C interface format and data read from a register of the slave device.

For example, the local serial interface processing unit 607 may access the I2C interface-based slave devices 610, 612 and 613 through the SCL line and the SDA line. Here, the data processing apparatus may be connected to the local serial interface processing unit 607, bypassing an SDA line and an SCL line connected from the interface processing unit 600 to the device address detection unit 603.

The data processing apparatus may connect to the slave devices 610, 612 and 613 from the local serial interface processing unit 607 via a bypass. That is, the data processing apparatus may transmit the signal in the I2C interface format from the interface processing unit 600 to the I2C interface-based slave devices 610, 612 and 613 through the I2C bus, bypassing the SDA line and the SCL line.

For example, local serial interface processing units 608 and 617 may be separately connected to slave devices 618 and 619 included in a slave device group 620 through independent SCL lines and SDA lines. Here, the local serial interface processing units 608 and 617 may identify a slave device to be accessed in a slave device group having the same device address through a device allocated address. For instance, the device allocation register in 604 may map each of the slave devices 618 and 619 having the same device address to a register field bit. Accordingly, the local serial interface processing unit 608 may identify the slave device to be accessed in the slave device group using the register field bit.

For example, the MII management interface processing unit 602 may receive and register device addresses of the PHY devices 615 and 616 or a group device address of a PHY device group 614 through the interface processing unit 600. The MII management interface processing unit 602 may register device relating information while the data processing apparatus is initialized or while the data processing apparatus is operating.

For instance, the MII management interface processing unit 602 may determine whether a device address of a PHY device included in the signal in the I2C interface format received from the serial interface processing unit is a registered device address. When the device address of the PHY device is a registered device address, the MII management interface processing unit 602 may access the PHY devices 615 and 616 or a PHY device included in the PHY device group 614. Alternatively, when the received device address is the group device address of the PHY device group 614, the MII management interface processing unit 602 may simultaneously access the PHY devices 615 and 616 included in the PHY device group 614 to process data.

The MII management interface processing unit 602 may receive a device address and a register address of a PHY device through an SCL line and an SDA line from the serial interface processing unit. Here, the device address may be configured in an N-bit format. For example, when the device address is configured using a 10-bit format, an MII signal may include five bits of the device address of the PHY device and five bits of the register address of the PHY device.

For example, the MII management interface processing unit 602 may determine whether a device address included in the received signal in the I2C interface format is a registered device address. When the received device address is a registered device address, the MII management interface processing unit 602 may conduct a process for accessing a PHY device allocated the receive device address. In detail, the MII management interface processing unit 602 may convert the I2C interface signal format into an MII signal format. Then, the MII management interface processing unit 602 may access the PRY device using the converted signal in the MII format.

For example, the I2C interface signal may provide a speed in a range of 600 KHz, and the MII signal may provide a speed in a range of 2.5 MHz. Accordingly, when the MII management interface processing unit 602 converts the I2C interface signal into the MII signal or vice versa, data loss may occur due to a speed difference between the I2C interface signal and the MII signal.

Thus, the format conversion storage unit 605 may store information included in the I2C interface signal or MII signal considering the speed difference between the I2C interface signal and the MII signal. The MII management interface processing unit 602 may convert the MII signal or the I2C interface signal based on the information stored in the format conversion storage unit 605.

The PHY device group 614 may include the PHY devices 615 and 616 allocated the separate device addresses. Internal registers of the PHY devices 615 and 616 may be identified using the device addresses of the PHY devices and the register addresses allocated to registers of the PHY devices. For example, when a 10-bit device address format is used, a device address and a register address of a PHY device may occupy 5 bits each.

For example, the device address of the PHY device may be set using an external pin. Referring to FIG. 6, the device address of the PHY device 615 may be set to “00001,” and the device address of the PHY device 616 may be set to “00010.”

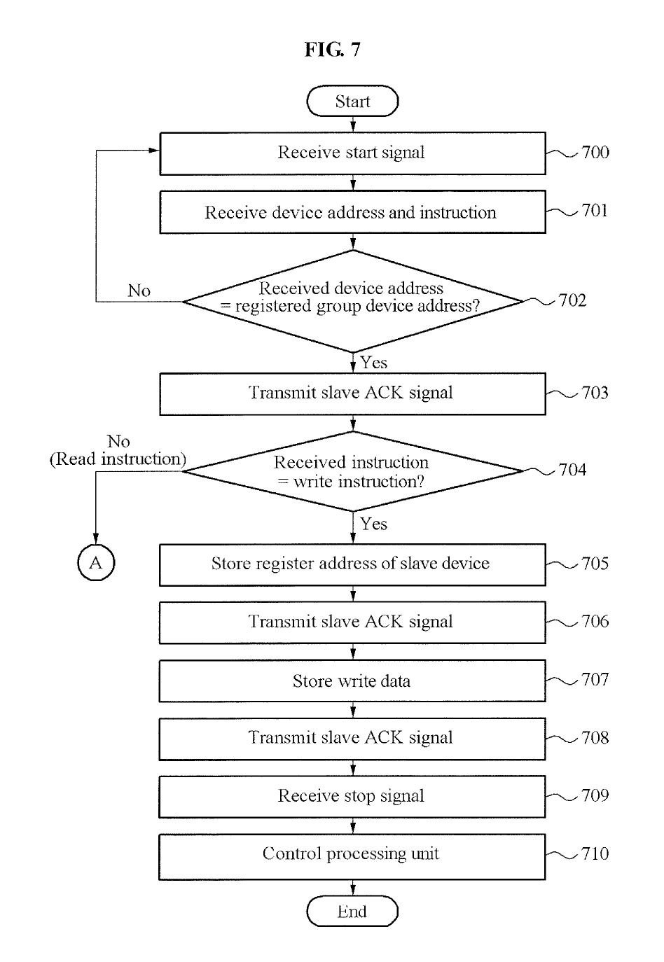

FIG. 7 illustrates a write instruction processing method of the data processing apparatus through the I2C protocol according to an embodiment.

Referring to FIG. 6, the data processing apparatus may include the serial interface processing unit, the parallel interface processing unit, the device address detection unit 603, the group address processing unit 606, the write information register, the device allocation register, the read information register, the plurality of local serial interface processing units 607, 608 and 617, the MII management interface processing unit 602, the format conversion storage unit 605 and the group address management unit 606. Here, a processing unit shown in FIG. 7 may include the plurality of local serial interface processing units 607, 608 and 617 and the group address management unit 606 of FIG. 6.

Referring to FIG. 7, in operation 700, the device address detection unit 603 may receive a start signal from the serial interface processing unit. In operation 701, the device address detection unit 603 may receive a device address of an I2C interface-based slave device and an R/W instruction bit.

In operation 702, the device address detection unit 603 may determine whether the received device address is a registered group device address. Here, when the received device address is not a registered group device address, the device address detection unit 603 may stop transmitting an acknowledgement (ACK) signal to the serial interface processing unit. In operation 703, when the received device address is a registered group device address, the device address detection unit 603 may transmit a slave ACK signal to the serial interface processing unit.

In operation 704, the device address detection unit 603 may determine which of a read instruction and a write instruction is input in the R/W instruction bit. When the write instruction is input in the R/W instruction bit, the device address detection unit 603 may receive a register address in the slave device from the serial interface processing unit and store the register address in the write information register in operation 705.

In operation 706, the device address detection unit 603 may transmit the slave ACK signal to the serial interface processing unit. Accordingly, the serial interface processing unit may recognize that the device address detection unit 603 receives the register address.

In operation 707, the device address detection unit 603 may receive write data from the serial interface processing unit and store the write data in the write information register. In operation 708, the device address detection unit 603 may transmit a slave ACK signal identifying that the write data is received to the serial interface processing unit.

In operation 709, the device address detection unit 603 may receive a stop signal from the serial interface processing unit. In operation 710, the device address detection unit 603 may control the group address processing unit 606 using information stored in the write information register and control information so that the local serial interface processing units 607, 608 and 617 corresponding to the group device address conduct the write instruction. Here, the control information may include the write instruction received from the serial interface processing unit.

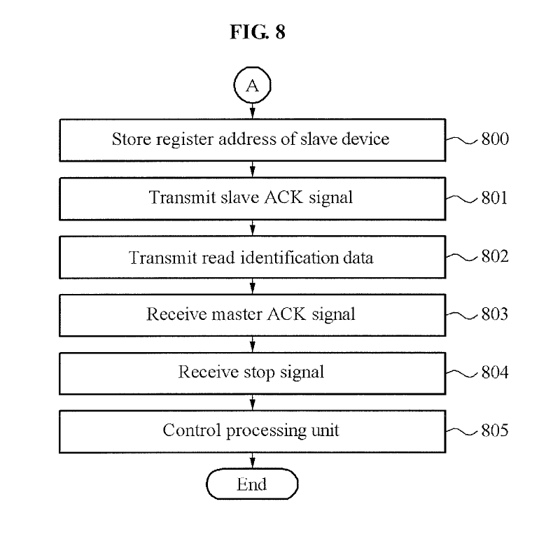

FIG. 8 illustrates a read instruction processing method of the data processing apparatus through the I2C protocol according to an embodiment.

The serial interface processing unit may determine which of a read instruction and a write instruction is input in the R/W instruction bit. When a bit input in the received R/W instruction bit is the read instruction, the device address detection unit 603 may receive a register address in the slave device from the serial interface processing unit in operation 800. Further, the device address detection unit 603 may store the register address in the slave device in the read information register. In operation 801, the device address detection unit 603 may transmit a slave ACK signal to the serial interface processing unit.

In operation 802, the device address detection unit 603 may transmit the preset read identification data between a higher processor and the data processing apparatus according to the I2C protocol to the serial interface processing unit. The serial interface processing unit may transmit a master ACK signal to the device address detection unit 603. For instance, the present invention may process a read instruction with respect to registers of one or more devices included in the group device address. Thus, the device address detection unit 603 may transmit the preset read identification data to the serial interface processing unit to finish conducting a read instruction started from the serial interface processing. The local serial interface processing units 607, 608 and 617 may collect content of a register in each slave device by conducting a read instruction. The local serial interface processing units 607, 608 and 617 may collect the content of the register in each slave device and transmit the content to the interface processing unit 600 through the local bus.

In operation 803, the device address detection unit 603 may receive a master ACK signal from the serial interface processing unit. In operation 804, the device address detection unit 603 may receive a stop signal from the serial interface processing unit. Accordingly, in operation 805, the device address detection unit 603 may control the group address processing unit 606 on the basis of information stored in the read information register and control information so that the local serial interface processing units 607, 608 and 617 corresponding to the group device address conduct the read instruction.

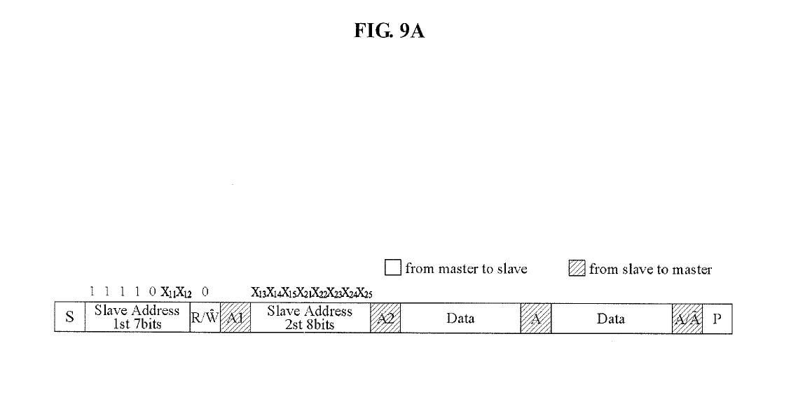

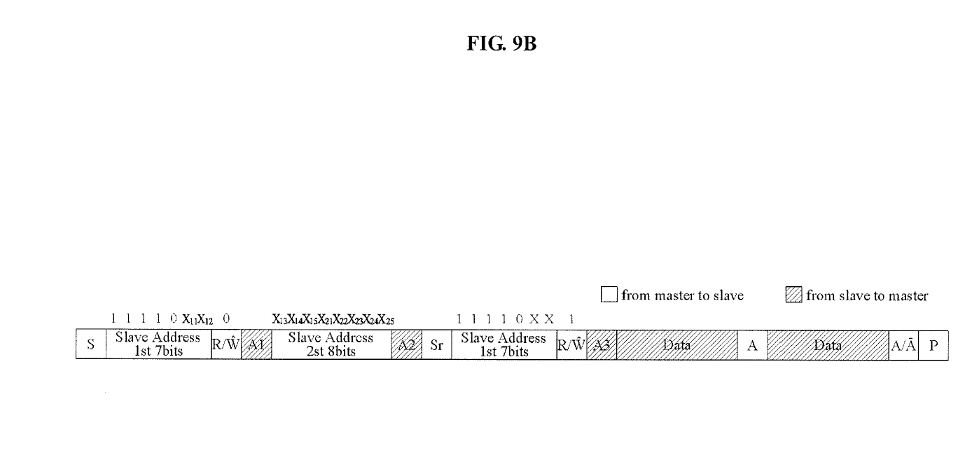

FIGS. 9A and 9B illustrate a format of a 10-bit address based on the I2C interface according to an embodiment.

The data processing apparatus may access an I2C interface-based slave device using an SCL line and an SDA line on the basis of the I2C interface. Further, the data processing apparatus may convert an I2C interface signal into an MII signal to access an MII-based PHY device. For example, referring to FIGS. 9A and 9B, the data processing apparatus may use a 10-bit address format in accordance with the I2C protocol. Here, even when the data processing apparatus is a central processing unit (CPU) not supporting the MII, the data processing apparatus may access the MII-based PHY device through the I2C interface.

The data processing apparatus may map the I2C 10-bit address to a physical address PHY_address and a register address REG_address of the MII-based PHY device. Here, the data processing apparatus may map the 10-bit address to the physical address PHY_address and the register address REG address of the PHY device by an administrator setting or at discretion of the data processing apparatus. Here, the physical address of the PHY device may refer to a device address of an MII-based slave device. The register address may refer to a register address of the MII-based slave device.

Referring to FIGS. 9A and 9B, the data processing apparatus may map the physical address of the MII-based PHY device to higher two bits X₁₁ and X₁₂ of first address bits and higher three bits X₁₃, X₁₄, and X₁₅ of second address bits. The data processing apparatus may also map the register address of the MII-based PHY device to five bits X₂₁, X₂₂, X₂₃, X₂₄, and X₂₅ of the second address bits. Alternatively, the device address and the register address may be mapped to random bits among one or more address bits, without being limited to the foregoing example.

FIG. 9A illustrates a format of an I2C interface signal for performing a write. Here, the format of the I2C interface signal for performing the write may include a 10-bit address bit. Thus. the format of the I2C interface signal for performing the write may be formed with 2 bytes.

First I2C interface bits may include a bit including 10-bit I2C address format information, higher N bits of device address bits of the PHY device, and a bit including R/W instruction information. Second I2C interface bits may include remaining bits of the device address bits of the PHY device except for the higher N bits.

For instance, when the I2C address format is 10 bits, bit 1′b11110 including information indicating that the first I2C address bits are the 10-bit I2C address format may be input. When device address bits of the PHY device are input in higher two bits among the ten bits of the first I2C address bits, the remaining device address bits of the PHY device may be input in lower eight bits of the second I2C address bits.

Referring to FIG. 9A, a master device may output a start S bit and a first slave address. Accordingly, a slave allocated the slave address may output an ACK signal A1. Here, the master device may refer to an I2C interface-based device. The slave may refer to a slave device. The slave address may refer to a device address allocated to the slave device.

The master device may output a second slave address. In response, the slave may output an ACK signal A2. The master device may output write data. When the write data is received, the slave device may output an ACK signal. When the write data is completely transmitted, the master device may output a stop bit to finish data processing.

FIG. 9B illustrates a format of an access signal for a read process. Here, the format of the access signal for the read process may occupy 10-bit address bits. Thus, the format of the access signal for the read process may occupy 2 bytes.

The master device may output a start S bit. The master device may output first slave address bits. A slave device allocated a first slave address may output an ACK signal A1. The master device may output second slave address bits. The slave device allocated a second slave address may output an ACK signal A2.

When the ACK signal A2 is received, the master device may output a restart Sr bit. The master device may output the first slave address bits. Here, the master device may input 1′b1 into an R/W bit for output. Here, 1′b1 may represent a read instruction.

Accordingly, the slave device allocated a slave address may output an ACK signal A3. The slave device may output read data stored in a register address in the slave device. Accordingly, the master device may read the data stored in the slave device.

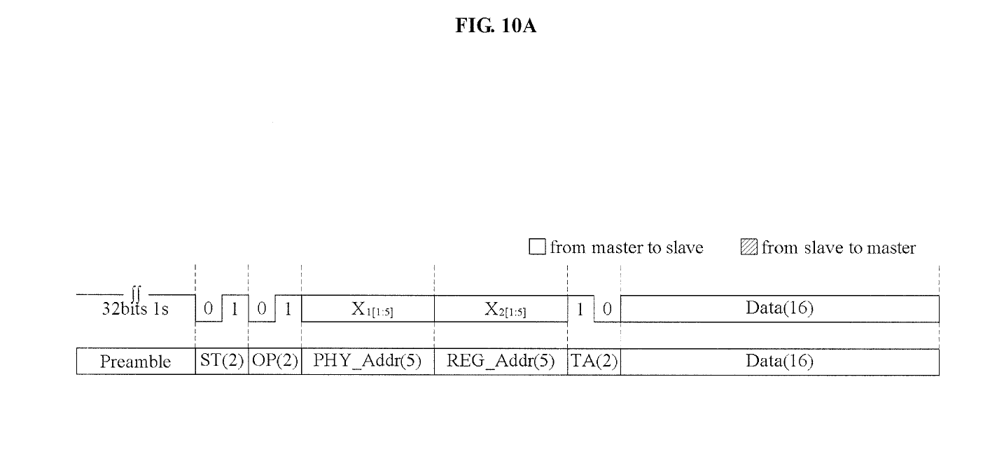

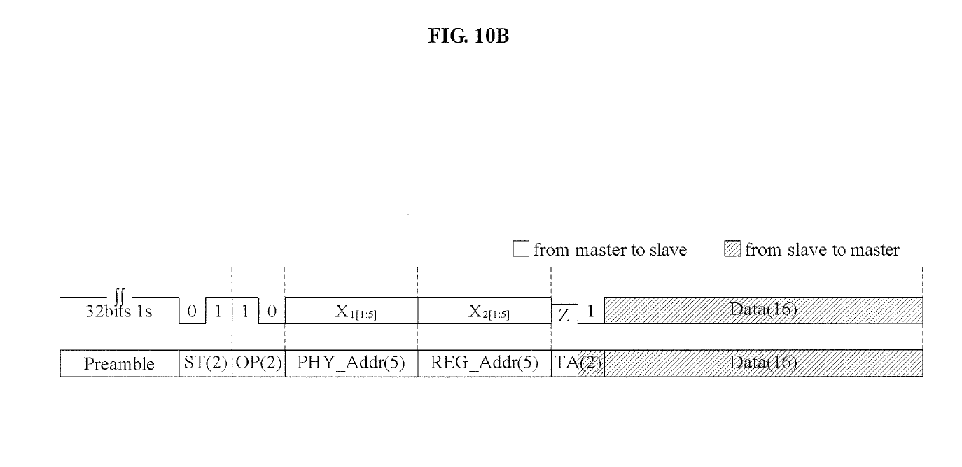

FIGS. 10A and 10B illustrate a format of an MII signal according to an embodiment. The MII may refer to a management interface between MAC (media access control) and PHY layers. In detail, the MII may access a PHY device using Media Data Clock (MDO)/Management Data Input/Output (MDIO) signal lines to process data. That is, the MII may perform management for data processing, such as Read/Write.

Referring to FIGS. 10A and 10B, the format of the MII signal may include preamble, start (ST), operation code (OP) and TA frames. The data processing apparatus may access the PHY device using the MII signal to conduct data processing, such as Read/Write. Referring to FIGS. 10A and 10B, the preamble frame may occupy 32 bits. The ST frame may occupy two bits, and the OP frame may occupy two bits. In addition, a physical address may occupy five bits, and a register address may occupy five bits. Further, the TA frame may occupy two bits, and write data may occupy 16 bits.

For instance, referring to FIG. 10A, the data processing apparatus may access the PHY device to perform a write. Referring to FIG. 10B, the data processing apparatus may access the PHY device to perform a read.

Referring to FIGS. 10A and 10B, values input in the ST, OP and TA may change according to a data processing instruction. In addition, in the case of a write, a frame format may transmit data from a master to a slave. In the case of a read, a frame format may transmit data from the slave to the master.

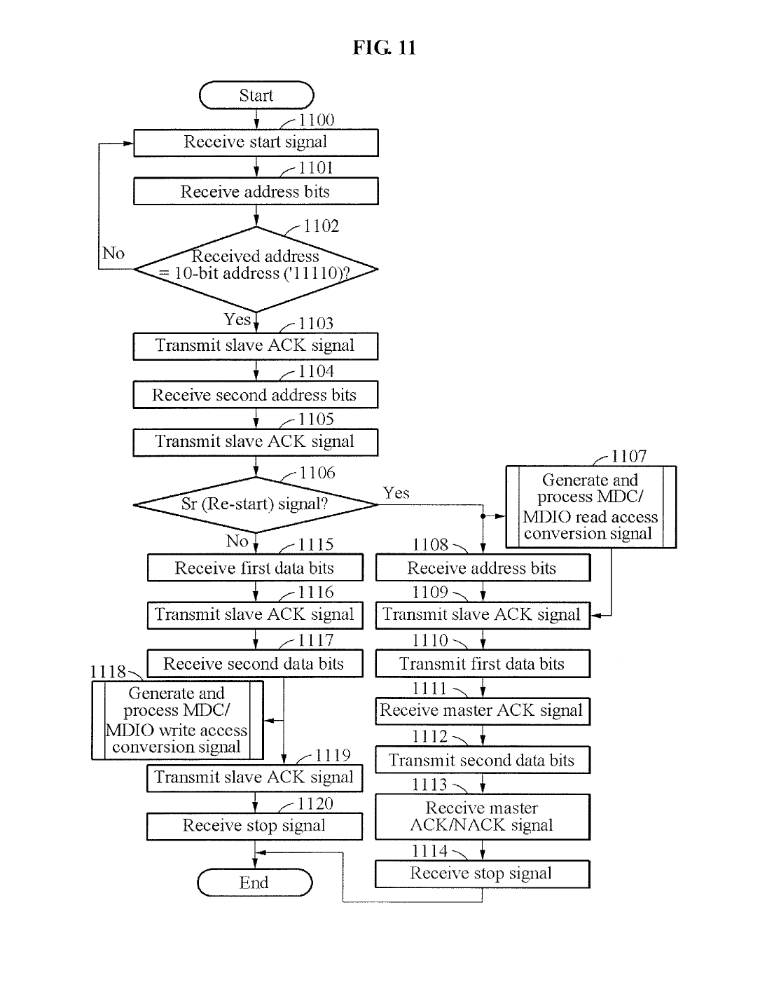

FIG. 11 illustrates a method of converting an I2C interface signal to an MII signal according to an embodiment.

Referring to FIG. 6, the MII management interface processing unit 602 of the data processing apparatus may receive the signal in the I2C interface format through the SCL line and the SDA line. Accordingly, in operation 1100, the MII management interface processing unit 602 may receive a start signal. In operation 1101, the MII management interface processing unit 602 may receive a signal including address bits. In detail, the interface processing unit 600 may transmit an I2C interface signal including the address bits to the MII management interface processing unit 602 through the SCL line and the SDA line. Here, the MII management interface processing unit 602 may determine whether to access a PHY device using the address bits. The PHY device may refer to an MII-based slave device. Here, the address bits may represent a device address value of an I2C slave device. The address bits may be, for example, seven bits or ten bits.

In operation 1102, the MII management interface processing unit 602 may determine whether to convert the I2C interface signal into an MII signal on the basis of information input in the address bits. In detail, when a device address of the PHY device or a group device address of a PHY device group is input in the address bits, the MII management interface processing unit 602 may convert the I2C interface signal into an MII signal. For instance, when “1111_{—}0xxx” is input in the address bits, the MII management interface processing unit 602 may recognize the address bits as 10-bit address bits for converting the I2C interface signal into an MII signal.

The MIT management interface processing unit 602 may extract a device address bit and a register address bit of the PHY device mapped to the address bits to store in the format conversion storage unit 605. Here, the device address bit of the PHY device may include a device address of an MII-based slave device or a group device address of a group of one or more MII-based slave devices. Further, the register address bit of the PHY device may include a register address in the MII-based slave device.

For instance, the device address bit and the register address bit of the PHY device may be mapped to address ten bits included in the I2C interface signal. Specifically, the device address bit and the register address bit of the PHY device may be mapped to an address bit of a first slave device and an address bit of a second slave device of an access signal using the I2C interface. The I2C interface signal may have an ACK field inserted between slave address fields to transmit an ACK signal.

For example, when “1111_{—}0xxx” is input in a first address bit, in operation 1103, the MII management interface processing unit 602 may transmit a slave ACK signal. In operation 1104, the MII management interface processing unit 602 may receive second address bits. The MII management interface processing unit 602 may extract a device address bit value and a register address bit value of the PHY device mapped to the first address bit and the second address bits. In operation 1105, the MII management interface processing unit 602 may transmit a slave ACK signal.

In operation 1106, the MII management interface processing unit 602 may determine whether a signal received from the serial interface processing unit includes a restart Sr signal. Accordingly, the MII management interface processing unit 602 may access the PHY device for data processing.

When the received signal includes no restart signal, the MII management interface processing unit 602 may access the PHY device to conduct a write. For example, when the received signal includes no restart signal, the MII management interface processing unit 602 may receive a first data bit in operation 1115. Accordingly, in operation 1116, the MIT management interface processing unit 602 may receive a slave ACK signal.

In operation 1117, the MII management interface processing unit 602 may receive a second data bit. In operation 1118, the MII management interface processing unit 602 may convert the I2C interface signal into an MII signal so as to access the PHY device to conduct a write. The MII management interface processing unit 602 may access the PHY device to conduct a write using the converted signal.

In operation 1119, the MII management interface processing unit 602 may transmit the slave ACK signal to the serial interface processing unit to report that data processing is finished. Accordingly, in operation 1120, the MII management interface processing unit 602 may receive a stop signal from the serial interface processing unit to finish data processing.

For example, when a write is performed, the MII management interface processing unit 602 may receive and store write data in the format conversion storage unit 605. When the write data is received, the MII management interface processing unit 602 may generate and transmit an ACK signal. Also, the MII management interface processing unit 602 may transmit a signal including preamble, ST and OP frames through an MDIO signal line. The MII management interface processing unit 602 may transmit physical address and register address information stored in the format conversion storage unit 605 through the MDIO signal line. Moreover, the MII management interface processing unit 602 may transmit a signal including a TA frame. In addition, the MII management interface processing unit 602 may receive write data information stored in the format conversion storage unit 605 and transmit the write data information through the MDIO signal line. Accordingly, when a stop signal P is received through the SDA line, the MII management interface processing unit 602 may finish conducting the write.

When the received signal includes the restart signal, the MII management interface processing unit 602 may generates a signal in the MII format so as to access the PHY device to conduct a read, thereby processing data.

In operation 1107, the MII management interface processing unit 602 may convert the I2C interface signal into an MII signal which enables access to the PHY device and implementation of a read. The MII management interface processing unit 602 may access the PHY device using the converted MII signal to process data.

In operation 1108, the MII management interface processing unit 602 may receive an address bit through the SDA line. In operation 1109, the MII management interface processing unit 602 may transmit a slave ACK signal.

In operation 1110, the MII management interface processing unit 602 may transmit eight bits of 16-bit data received from the PHY device. In operation 1111, the MII management interface processing unit 602 may receive a master ACK signal from the serial interface processing unit.

In operation 1112, the MII management interface processing unit 602 may transmit remaining eight bits of the data received from the PHY device. In operation 1113, the MII management interface processing unit 602 may receive a master signal or NACK signal from the serial interface processing unit. In operation 1114, when the stop signal is received through the SDA line, the MII management interface processing unit 602 may finish conducting the read.

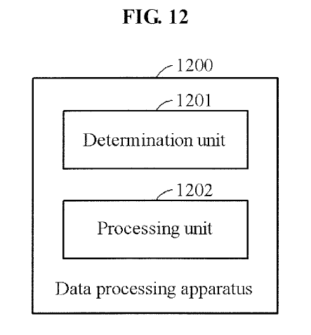

FIG. 12 illustrates a data processing apparatus which processes data by accessing a slave device group through a group device address according to an embodiment.

Referring to FIG. 12, a determination unit 1201 may determine whether a device address included in a data processing request signal received from a master device is a registered group device address. Here, the determination unit 1201 may correspond to the device address detection unit 603.

When the device address is a registered group device address, the processing unit 1202 may access one or more slave devices mapped to the registered group device address to process data. Here, the processing unit 1202 may correspond to the group address processing unit and the local serial interface processing units.

Here, the data processing apparatus 1200 may group one or more slave devices according to a preset criterion to map the slave devices to a group device address. Here, the preset criterion may mean that slave devices have the same device address or have the same register. In detail, slave devices having the same register may mean that the slave devices have the same higher bits to have the same internal register maps.

The data processing apparatus 1200 may register the mapped group device address to access the slave devices using the group device address, separately from accessing the slave devices through a device address. Here, the data processing apparatus 1200 may register the mapped group device address when the data processing apparatus 1200 is initialized or while the data processing apparatus 1200 is operating.

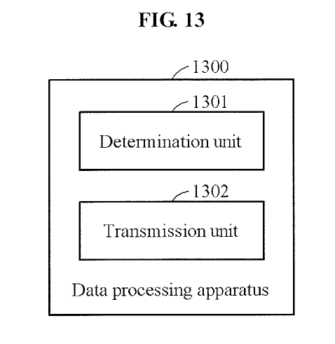

FIG. 13 illustrates a data processing apparatus which processes data by accessing a slave device through a device address according to an embodiment.

Referring to FIG. 13, a determination unit 1301 may determine whether a device address included in a data processing request signal received from a master device is a registered group device address. Here, the determination unit 1301 may correspond to the device address detection unit.

When the received device address is a device address, the transmission unit 1302 may transmit a data processing instruction to a slave device allocated the device address. Here, the transmission unit 1302 may correspond to the local serial interface processing units 607, 608 and 617 of FIG. 6. That is, when the device address included in the signal received from the master device is not a group device address but a device address allocated to an individual slave device, the data processing apparatus may transmit the data processing instruction to the slave device corresponding to the device address included in the received signal.

Here, the data processing apparatus 1300 may transmit the data processing instruction via a bypass to the slave device allocated the individual device address. Accordingly, the slave device may determine whether to process data on the basis of the device address included in the data processing instruction. When the device address included in the data processing instruction corresponds with the device address of the slave device receiving the data processing instruction, the data processing apparatus may access the slave device to process data.

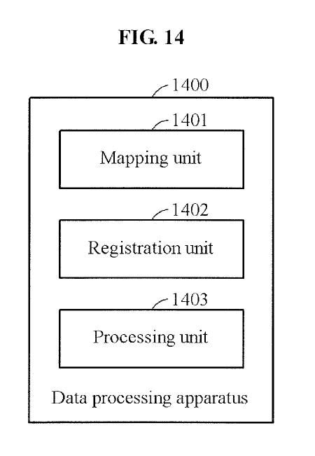

FIG. 14 illustrates a data processing apparatus which processes data by accessing a slave device group through registration of a group device address according to an embodiment.

Referring to FIG. 14, a mapping unit 1401 may group one or more slave devices according to a preset criterion and map the slave devices to a group device address. Here, the mapping unit 1401 may correspond to the group address management unit 601 of FIG. 6.

For example, the preset criterion may specify that one or more slave devices having the same device address or one or more slave devices having the same register are grouped and mapped to a group device address. In detail, slave devices having the same register may mean that the slave devices have the same higher bits to have the same internal register maps.

A registration unit 1402 may register the mapped group device address. Here, the registration unit 1402 may mean the device address detection unit. A processing unit 1403 may access one or more slave devices corresponding to the registered group device address to process data. Here, the processing unit 1403 may correspond to the group address processing unit 606 and the local serial interface processing units 607, 608 and 617 of FIG. 6. Accordingly, the processing unit 1403 may access registers of the one or more slave devices to process data.

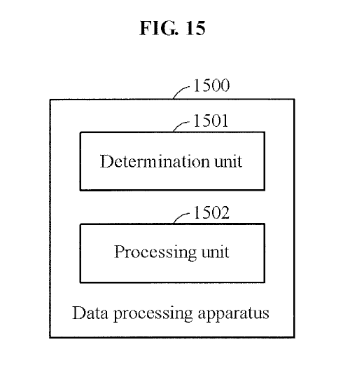

FIG. 15 illustrates a data processing apparatus which processes data by an integrated circuit serial interface-based device accessing a Media Independent Interface-based device according to an embodiment.

A determination unit 1501 may receive a signal from the integrated circuit serial interface-based master device. Here, an integrated circuit serial interface may refer to an I2C interface. The Media Independent Interface may be represented by MII. The signal may be a signal for accessing an integrated circuit serial interface-based slave device. Here, the determination unit 1501 may determine whether to access the MII-based slave device using identification information included in the signal received from the integrated circuit serial interface-based master device.

In detail, when the identification information included in the signal received from the integrated circuit serial interface-based master device corresponds with a preset criterion, the determination unit 1501 may access the MII-based slave device. Here, the preset criterion may be set at discretion by an administrator or by the data processing apparatus 1500.

For example, the determination unit 1501 may receive a signal including first address bits with a “1111_{—}0xxx” input through an SCL line and an SDA line. Here, “1111_{—}0xxx” may represent identification information. When the identification information in accordance with the preset criterion by the data processing apparatus 1500 includes “1111_{—}0xxx,” the determination unit 1501 may access the MII-based slave device.

When the determination unit 1501 accesses the MII-based slave device, the determination unit 1501 may determine whether the device address included in the signal received from the master device is a device address of the MII-based slave device or a group device address of one or more MII-based slave device groups.

Accordingly, the determination unit 1501 may convert the received signal into an MII format to access the MII-based slave device. For example, the data processing apparatus 1500 may register the device address of the MII-based slave device. Also, the data processing apparatus 1500 may store a device address of an MII-based slave device group. Here, the data processing apparatus 1500 may adjust the device address of the MII-based slave device through an external pin to identify a slave device included in the slave device group.

For instance, the signal received by the data processing apparatus 1500 from the integrated circuit serial interface-based master device may be mapped to the device address of the MII-based slave device and a register address thereof mapped. Accordingly, the determination unit 1501 may determine whether the device address of the MII-based slave device mapped to the received signal is registered.

When the device address of the MII-based slave device mapped to the received signal is determined to be registered in the data processing apparatus, the determination unit 1501 may access a register of the MII-based slave device corresponding to the device address and register address.

A processing unit 1502 may access the MII-based slave device to process data. In detail, the processing unit 1502 may convert the signal received from the integrated circuit serial interface-based master device into an MIT format. Accordingly, the processing unit 1502 may access the MII-based slave device using the converted signal, thereby processing data.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Thus, other implementations, alternative embodiments and equivalents to the claimed subject matter are construed as being within the appended claims.

What is claimed is:

1. A method of processing data comprising:
determining whether a device address comprised in a signal received from a master device is a registered group device address; and
processing data by accessing one or more slave devices mapped to the registered group device address when the device address is the registered group device address.

2. The method of claim 1, further comprising:
grouping one or more slave devices according to a preset criterion to map the slave devices to a group device address; and
registering the mapped group device address.

3. The method of claim 2, wherein the registering registers the mapped group device address when a data processing apparatus is initialized or while the data processing apparatus is operating.

4. The method of claim 1, further comprising:
transmitting a data processing instruction to a slave device allocated a device address when the device address is the device address allocated to the slave device.

5. The method of claim 4, further comprising:
grouping one or more slave devices according to a preset criterion to map the slave devices to a group device address; and
registering the mapped group device address.

6. The method of claim 4, wherein the transmitting transmits the data processing instruction to the slave device via a bypass.

7. A method of processing data comprising:
grouping one or more slave devices according to a preset criterion to map the slave devices to a group device address;
registering the mapped group device address; and
processing data by accessing one or more slave devices corresponding to the registered group device address.

8. The method of claim 7, wherein the mapping groups one or more slave devices having the same device address or one or more slave devices having the same register and maps the slave devices to a group device address.

9. A method of processing data comprising:
determining whether to access an Media Independent Interface (MII)-based slave device using identification information comprised in a signal received from an integrated circuit serial interface-based master device; and
processing data by accessing the MII-based slave device or an MII-based slave device group when it is determined to access the MII-based slave device.

10. The method of claim 9, wherein the determining converts the received signal into an MII format when the identification information comprised in the received signal corresponds to identification information in accordance with a preset criterion.

11. The method of claim 9, wherein the received signal is mapped to a device address and a register address of the MII-based slave device.

12. The method of claim 9, wherein the determining comprises determining whether a device address of the MII-based slave device mapped to the received signal is registered; and accessing the MII-based slave device corresponding to the device address or the MII-based slave device group when the device address is determined to be registered.
